(19) United States
(12) Patent Application Publication
(10) Pub. No.: US 2014/0178056 A1
(43) Pub. Date: Jun. 26, 2014

(54) APPARATUS AND METHOD FOR BAKING SUBSTRATE

(71) Applicants: Meina Zhu, Shenzhen (CN); Yi Dai, Shenzhen (CN)

(72) Inventors: Meina Zhu, Shenzhen (CN); Yi Dai, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/704,300

(22) PCT Filed: Sep. 28, 2012
(86) PCT No.: PCT/CN2012/082355

§ 371 Date: Dec. 14, 2012

(30) Foreign Application Priority Data
Sep. 26, 2012 (CN) 201210363515.9

(51) Int. Cl. C03C 23/00; H05B 3/00; C03C 17/00

(52) U.S. Cl. CPC C03C 23/007; C03C 23/0085; C03C 17/002; H05B 3/0047; H05B 3/009
USPC 392/411; 392/418; 392/416

(57) ABSTRACT

The present invention discloses an apparatus for baking a substrate. The apparatus includes a supporting platform, a plurality of supporting pins, a heating unit, and a thermal insulation layer. The supporting platform has a supporting surface and a bottom surface. The supporting pins are disposed in the supporting platform, and the supporting pins are capable of movably protruding from the supporting surface to lift the substrate up. The heating unit is utilized to heat the substrate. The thermal insulation layer is disposed opposite to the bottom surface of the supporting platform and utilized to prevent the heating unit from heating the supporting platform. The present invention further discloses a method for baking a substrate, and the method can effectively prevent a Mura defect appearing on the substrate.

### FIELD OF THE INVENTION

The present invention relates to a liquid crystal display technology, and especially to an apparatus and a method for baking a substrate.

### BACKGROUND OF THE INVENTION

In conventional manufacturing processes of a liquid crystal substrate, a glass substrate with polyimide (PI) solution thereon requires prebaking. A way of the baking is to radiate the glass substrate by using infrared rays for heating the glass substrate to 90 degrees Celsius, thereby evaporating solvent of the PI solution to increase a density of the PI solution. In said baking process, support pins are usually employed to support the glass substrate. But since material of support pins are not heat-insulating completely, there is a difference of thermal conductivity existing between a contact region (contact area of support components on the glass substrate) and a noncontact region (noncontact area of the support components on the glass substrate). Thus, the glass substrate is heated unevenly, resulting in a “Mura defect” appearing on the glass substrate, such that a product yield of the glass substrate is decreased.

In order to prevent the Mura defect appearing on the glass substrate, there were two conventional solutions as following. One is that the support pins are made of material with a better heat-insulating performance, thereby reducing a temperature difference between the contact regions of the support pins and other regions. The other is that support pins are controlled so as to alternately support the glass substrate for reducing time that the support pins contact the glass substrate at the same places. That is, parts of the support pins are utilized to support the glass substrate first, and then the other support pins are utilized to support the glass substrate after a predetermined time.

Both said two solutions can not prevent the Mura defect from appearing on the glass substrate; the reason for this is the following. Firstly, said two solutions can not preclude the existence of the temperature difference between the different regions on the glass substrate. Secondly, in said two solutions, the way by using the support pins to support the glass substrate will make pressures of the contact regions between the glass substrate and the support pins too large, such that the glass substrate is deformed for making the glass substrate be heated unevenly, resulting the Mura defect appearing in the baking process. Thirdly, in said two solutions, because the support pins are needlelike, it is a disadvantage to keep a flatness of the glass substrate within the baking process. It is easy to cause the Mura defect of a halo appearing.

Therefore, there is a significant need to provide a new technical solution for solving the technical problem of the Mura defect appearing on the glass substrate.

### SUMMARY OF THE INVENTION

An objective of the present invention is to provide an apparatus for baking a substrate, and the apparatus can effectively prevent a Mura defect appearing on the substrate.

To achieve the foregoing objective, a preferred embodiment of the present invention provides an apparatus for baking a substrate. The apparatus includes a supporting platform, a plurality of supporting pins, a heating unit, and a thermal insulation layer. The supporting platform has a supporting surface and a bottom surface. The supporting pins are disposed in the supporting platform, and the supporting pins are capable of movably protruding from the supporting surface to lift the substrate up. The heating unit is utilized to heat the substrate. The thermal insulation layer is disposed opposite to the bottom surface of the supporting platform and utilized to prevent the heating unit from heating the supporting platform.

In the apparatus for baking a substrate according to the preferred embodiment, the heating unit includes a first electrothermal board and a second electrothermal board. The first electrothermal board is disposed above the supporting pins, and the substrate is located between the first electrothermal board and the supporting pins. The second electrothermal board is disposed below the supporting platform and faces the bottom surface of the supporting platform. Furthermore, the thermal insulation layer is utilized to obstruct the second electrothermal board heating the supporting platform. Preferably, the thermal insulation layer is made of porous material, heat-reflecting material, or vacuum material.

In the apparatus for baking a substrate according to the preferred embodiment, the supporting platform has a plurality of through holes defined therein, and the through holes are utilized to receive the supporting pins. The substrate is lifted up by the supporting pins when the supporting pins protrude from the supporting surface; the substrate is placed on the supporting surface when the supporting pins are received in the through holes. Moreover, the heating unit stops heating when the substrate is lifted up; the heating unit heats up when the substrate is placed on the supporting surface.

Another objective of the present invention is to provide a method for baking a substrate, and the method can effectively prevent a Mura defect appearing on the substrate.

To achieve the foregoing objective, a preferred embodiment of the present invention provides a method for baking a glass substrate by using a supporting platform, a plurality of supporting pins disposed in the supporting platform, and a heating unit. The method includes the following steps of: pushing the supporting pins out of the supporting surface of the supporting platform; placing the substrate on the supporting pins; retracting the supporting pins into the supporting platform for the substrate being placed on the supporting surface; disposing a thermal insulation layer opposite to a bottom surface of the supporting platform; and heating the substrate by the heating unit.

In the method for baking a substrate according to the preferred embodiment, the step of heating includes: disposing a first electrothermal board above the supporting pins, and the substrate located between the first electrothermal board and the supporting pins; and disposing a second electrothermal board below the supporting platform for facing the bottom surface of the supporting platform. Specifically, the thermal insulation layer is disposed between the second electrothermal board and the supporting platform.

In comparison with the prior art, the supporting pins fall before heating, so that the substrate directly contacts the supporting surface of the supporting platform. That is, the point contact in the prior art changes to a surface contact. Thus, while the heating unit heats the substrate, the non-uniform heat transfer stemming from the point contact of the supporting pins is not generated; hence the problem of the Mura defect appearing on the substrate is overcome. Meanwhile, by the thermal insulation layer obstructing the second electrothermal board from heating the supporting platform, the temperature difference would not be formed due to the non-uniform heating, so that the temperature of the supporting surface keeps identical. Therefore, the surface of the substrate, which is placed on the supporting surface of the supporting platform, can be baked uniformly by the first electrothermal board, thereby precluding the formation of the Mura defect on a PI film.

It is to be understood that both the foregoing general description and the following detailed description of the present invention are exemplary and explanatory and are intended to provide further explanation of the invention as claimed.

### DESCRIPTION OF THE DRAWINGS

FIG. 1 is a sectional view illustrating an apparatus for baking a substrate according to one preferred embodiment of the present invention;

FIG. 2 is a cross-sectional view illustrating the apparatus of FIG. 1 being baking the substrate;

FIG. 3 is a sectional view illustrating an apparatus for baking a substrate according to another preferred embodiment of the present invention; and

FIG. 4 is a flow chart illustrating a method for baking a glass substrate according to a preferred embodiment of the present invention.

### DETAILED DESCRIPTION OF THE PREFERRED EMBODIMENTS

Descriptions of the following embodiments refer to attached drawings which are utilized to exemplify specific embodiments. In different drawings, the same reference numbers will be used throughout the drawings to refer to the same or like parts.

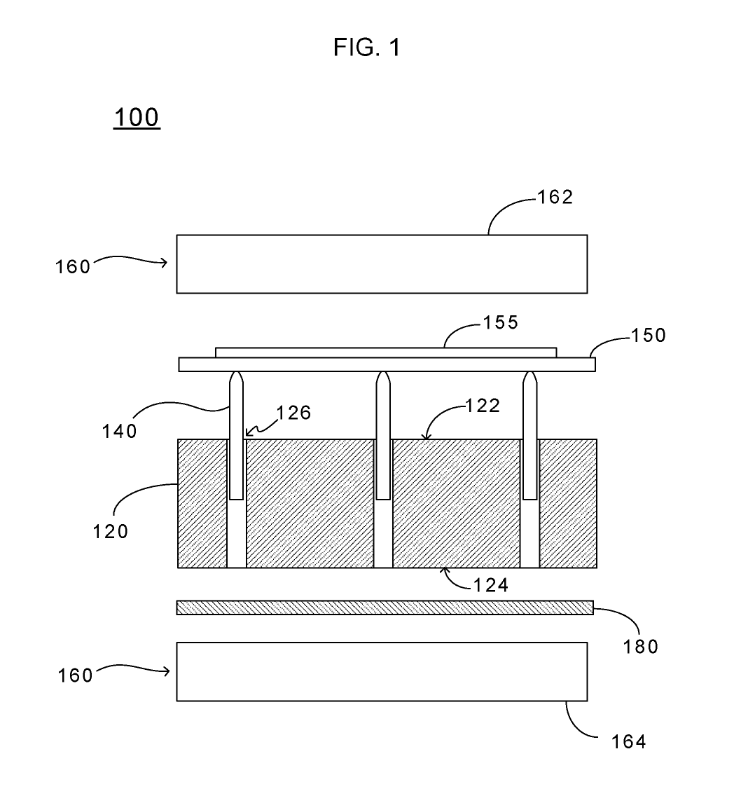

Referring to FIG. 1, FIG. 1 is a sectional view illustrating an apparatus for baking a substrate according to one preferred embodiment of the present invention. The apparatus 100 for baking a substrate 150 according to the preferred embodiment includes a supporting platform 120, a plurality of supporting pins 140, a heating unit 160, and a thermal insulation layer 180. It is worth mentioning that material of the substrate 150 is not limited in the present invention. The substrate can be a glass substrate and also can be a flexible substrate that is made of plastic. There is a solution 155 of an alignment film on the substrate 150.

The supporting platform 120 is disposed in a heating chamber (not shown), and the supporting platform 120 has a supporting surface 122 and a bottom surface 124. The supporting platform 120 has a plurality of through holes 126 defined therein; the through holes 126 utilized to receive the supporting pins 120. In the embodiment, the through hole 126 goes through the supporting surface 122 and the bottom surface 124. However, in other embodiments, the through holes 126 can be only defined on the supporting surface 122.

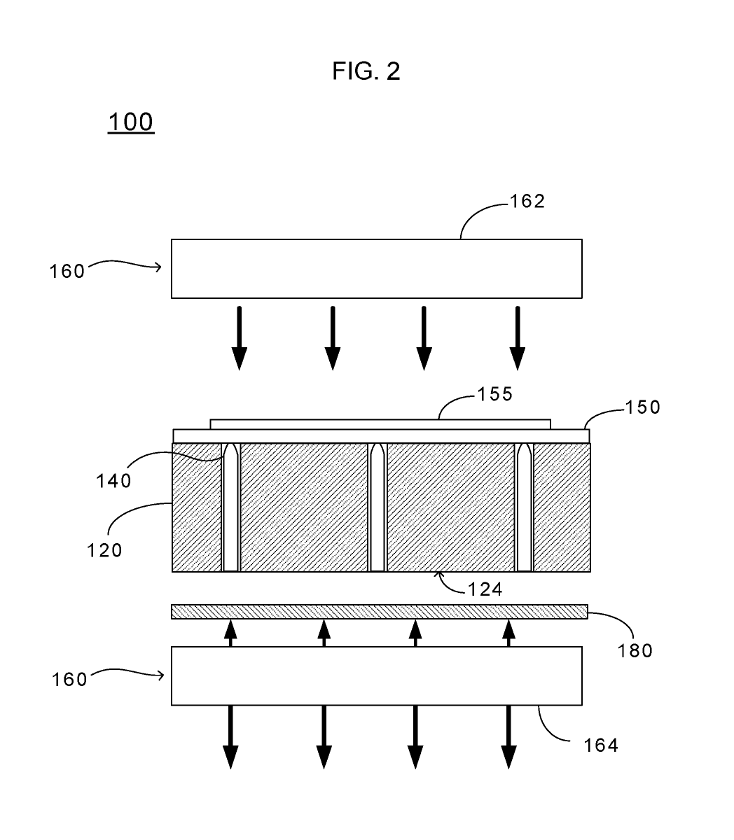

Referring to FIG. 1 and FIG. 2, FIG. 2 is a cross-sectional view illustrating the apparatus of FIG. 1 being baking the substrate. The supporting pins 140 are disposed in the supporting platform 120, and the supporting pins 140 are capable of movably protruding from the supporting surface 122 to lift the substrate 150 up. More specifically, the supporting pins 140 can be coupled to a driving device (not shown). For example, the supporting pins 140 can be driven to protrude from the supporting surface 122 or to retract and be received in the supporting platform 120 by means of electricity, a pneumatic or hydraulic machine.

Referring to FIG. 1 and FIG. 2, the heating unit 160 is utilized to heat the substrate 150. In the embodiment, the heating unit 160 includes a first electrothermal board 162 and a second electrothermal board 164. The first electrothermal board 160 is disposed above the supporting pins 140, and the substrate 150 is located between the first electrothermal board 162 and the supporting pins 140. The second electrothermal board 164 is disposed below the supporting platform 120 and faces the bottom surface 124 of the supporting platform 120.

Referring to FIG. 1 and FIG. 2, when the supporting pins 140 protrude from the supporting surface 122, the substrate 150 is lifted up by the supporting pins 140. When the supporting pins 140 are received in the through holes 126, the substrate 150 is placed on the supporting surface 122. As shown in FIG. 1, when the substrate 150 is lifted up, the heating unit 160 stops heating. As shown in FIG. 2, when the substrate 150 is placed on the supporting surface 122, the heating unit heats up.

As shown in FIG. 2, the thermal insulation layer 180 is disposed opposite to the bottom surface 124 of the supporting platform 120 and utilized to prevent the heating unit 160 from heating the supporting platform 120, in which heat radiation is indicated as dashed arrows. The thermal insulation layer 180 is made of porous material, heat-reflecting material, or vacuum material. In the embodiment, the thermal insulation layer 180 is utilized to obstruct the second electrothermal board 164 heating the supporting platform 120, so that the temperature on the supporting surface 122 of the supporting platform 120 keeps uniform. Therefore, when the first electrothermal board 162 heats the substrate 150, non-uniform heat does not play on the contact surface of the substrate 150 with the supporting platform 120 due to the media with different heat transfers.

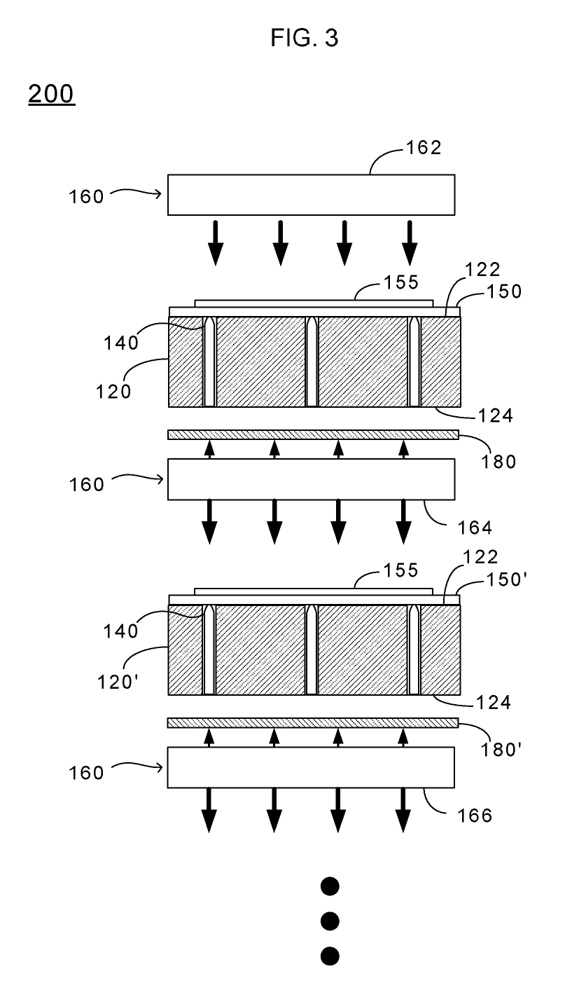

It is worth mentioning that multiple substrates 150 can be baked simultaneously in an apparatus for baking a substrate of other embodiments. Referring to FIG. 3, FIG. 3 is a sectional view illustrating an apparatus for baking a substrate according to another preferred embodiment of the present invention.

The apparatus 200 for baking substrates 150 according to the embodiment includes a plurality of supporting platforms 120, supporting pins 140, heating units 160, and thermal insulation layers 180. Similarly, the supporting platform 120 has a supporting surface 122 and a bottom surface 124. The supporting pins 140 are disposed in the supporting platform 120, and the supporting pins 140 are capable of movably protruding from the supporting surface 122 to lift the substrate 150 up, as shown in FIG. 1. The heating unit 160 is utilized to heat the substrate 150. The thermal insulation layer 180 is disposed opposite to the bottom surface 124 of the supporting platform 120 and utilized to prevent the heating unit 160 from heating the supporting platform 120.

Similarly, the heating unit 160 includes a first electrothermal board 162, a second electrothermal board 164, a third electrothermal board 166, and so forth. One difference from the above-mentioned embodiment is that the thermal insulation layer 180 is utilized to obstruct the second electrothermal board 164 heating the supporting platform 120. Furthermore, the second electrothermal board 164 is capable of heating the substrate 150′ of a lower layer. Moreover, the thermal insulation layer 180′ of the lower layer is utilized to obstruct the third electrothermal board 166 heating the supporting platform 120′ of the lower layer. It can be seen from the foregoing that the apparatus 200 of the embodiment can simultaneously bake the multiple substrates 150, and preclude the formation of the Mura defect.

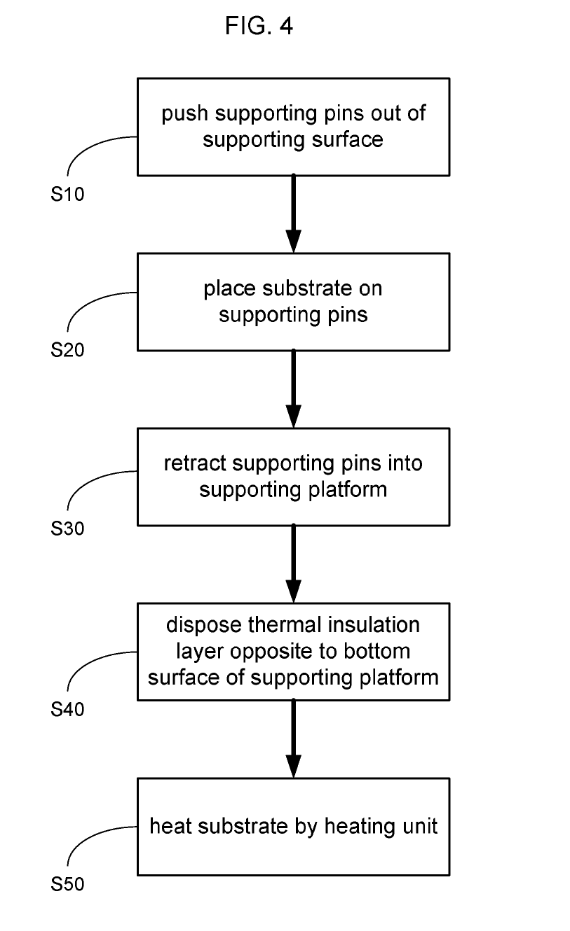

Referring to FIG. 1, FIG. 2, and FIG. 4, FIG. 4 is a flow chart illustrating a method for baking a glass substrate according to a preferred embodiment of the present invention. The method for baking a glass substrate according to the preferred embodiment of the present invention employs the supporting platform 120 of the above-mentioned embodiment, which has the plurality of supporting pins 140 and the heating unit 160 disposed in the supporting platform 120. The method begins with step S10.

At step S10, the supporting pins 140 are pushed out of the supporting surface 122 of the supporting platform 120. For example, the supporting pins 140 can be coupled to a driving device (not shown). For instance, the supporting pins 140 can be driven to protrude from the supporting surface 122 or to retract and be received in the supporting platform 120 by means of electricity, a pneumatic or hydraulic machine.

At step S20, the substrate 150 is placed on the supporting pins 140, as shown in FIG. 1. In the embodiment, a robot arm (not shown) can be employed for holding the substrate 150 and placing it on the protruded the supporting pins 140, whereby the robot arm has enough space to retract.

At step S30, the supporting pins 140 retract into the supporting platform 120 for the substrate 150 being placed on the supporting surface 122, as shown in FIG. 2.

At step S40, the thermal insulation layer 180 is disposed opposite to the bottom surface 124 of the supporting platform 120 and utilized to prevent the heating unit 160 from heating the supporting platform 120.

At step S50, the heating unit 160 is utilized to heat the substrate 150.

Referring to FIG. 3 again, it should be noted that the heating step of step S50 further includes: step S52 of disposing a first electrothermal board above the supporting pins, in which the substrate is located between the first electrothermal board and the supporting pins; and step S54 of disposing a second electrothermal board 164 below the supporting platform 120 for facing the bottom surface 124 of the supporting platform 120. In the method, the thermal insulation layer 180 is disposed between the second electrothermal board 164 and the supporting platform 120.

In summary, the supporting pins 140 fall before heating, so that the substrate 150 directly contacts the supporting surface 122 of the supporting platform 120. That is, the conventional point contact changes to the surface contact. Thus, while the heating unit 160 heats the substrate 160, the non-uniform heat transfer stemming from the point contact of the supporting pins 140 is not generated; hence the problem of the Mura defect appearing on the substrate 150 is overcome. Meanwhile, by the thermal insulation layer 180 obstructing the second electrothermal board 164 from heating the supporting platform 120, the temperature difference would not be formed due to the non-uniform heating, so that the temperature of the supporting surface 122 keeps identical. Therefore, the surface of the substrate 150, which is placed on the supporting surface 122 of the supporting platform 120, can be baked uniformly by the first electrothermal board 162, thereby precluding the formation of the Mura defect on the PI film.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An apparatus for baking a glass substrate, comprising:
a supporting platform having a supporting surface and a bottom surface;
a plurality of supporting pins disposed in the supporting platform, the supporting pins be capable of movably protruding from the supporting surface to lift the substrate up;
a heating unit comprising a first electrothermal board and a second electrothermal board, the first electrothermal board disposed above the supporting pins, and the substrate located between the first electrothermal board and the supporting pins; the second electrothermal board disposed below the supporting platform for facing the bottom surface of the supporting platform; and
a thermal insulation layer disposed opposite to the bottom surface of the supporting platform and utilized to obstruct the second electrothermal board heating the supporting platform.

2. The apparatus according to claim 1, wherein the thermal insulation layer is made of porous material, heat-reflecting material, or vacuum material.

3. The apparatus according to claim 1, wherein the supporting platform has a plurality of through holes defined therein, the through holes utilized to receive the supporting pins.

4. The apparatus according to claim 3, wherein the substrate is lifted up by the supporting pins when the supporting pins protrude from the supporting surface; the substrate is placed on the supporting surface when the supporting pins are received in the through holes.

5. The apparatus according to claim 4, wherein the heating unit stops heating when the substrate is lifted up; the heating unit heats up when the substrate is placed on the supporting surface.

6. An apparatus for baking a glass substrate, comprising:
a supporting platform having a supporting surface and a bottom surface;
a plurality of supporting pins disposed in the supporting platform, the supporting pins be capable of movably protruding from the supporting surface to lift the substrate up;
a heating unit utilized to heat the substrate; and
a thermal insulation layer disposed opposite to the bottom surface of the supporting platform and utilized to prevent the heating unit from heating the supporting platform.

7. The apparatus according to claim 6, wherein the heating unit comprises a first electrothermal board and a second electrothermal board, the first electrothermal board disposed above the supporting pins, and the substrate located between the first electrothermal board and the supporting pins; the second electrothermal board disposed below the supporting platform for facing the bottom surface of the supporting platform.

8. The apparatus according to claim 7, wherein the thermal insulation layer is utilized to obstruct the second electrothermal board heating the supporting platform.

9. The apparatus according to claim 6, wherein the thermal insulation layer is made of porous material, heat-reflecting material, or vacuum material.

10. The apparatus according to claim 6, wherein the supporting platform has a plurality of through holes defined therein, the through holes utilized to receive the supporting pins.

11. The apparatus according to claim 10, wherein the substrate is lifted up by the supporting pins when the supporting pins protrude from the supporting surface; the substrate is placed on the supporting surface when the supporting pins are received in the through holes.

12. The apparatus according to claim 11, wherein the heating unit stops heating when the substrate is lifted up; the heating unit heats up when the substrate is placed on the supporting surface.

13. A method for baking a glass substrate by using a supporting platform, a plurality of supporting pins disposed in the supporting platform, and a heating unit; the method comprising the following steps of:
pushing the supporting pins out of the supporting surface of the supporting platform;
placing the substrate on the supporting pins;
retracting the supporting pins into the supporting platform for the substrate being placed on the supporting surface;
disposing a thermal insulation layer opposite to a bottom surface of the supporting platform; and
heating the substrate by the heating unit.

14. The method according to claim 13, wherein the step of heating comprises:
disposing a first electrothermal board above the supporting pins, and the substrate located between the first electrothermal board and the supporting pins; and
disposing a second electrothermal board below the supporting platform for facing the bottom surface of the supporting platform.

15. The method according to claim 14, wherein the thermal insulation layer is disposed between the second electrothermal board and the supporting platform.
